(19) United States
(12) Patent Application Publication
(10) Pub. No.: US 2008/0107305 A1
(43) Pub. Date: May 8, 2008

(54) INTEGRATED MAPPING SYSTEM

(75) Inventors: Geoffrey E. Vanderkooy, Waterloo (CA); Jeffrey Scott Biegus, Guelph (CA); Terry Harold Fisher, Waterloo (CA)

Correspondence Address: FISH & RICHARDSON PC, P.O. BOX 1022, MINNEAPOLIS, MN, 55440-1022, US

(73) Assignee: NORTHERN DIGITAL INC., Waterloo (CA)

(21) Appl. No.: 11/934,333

(22) Filed: Nov. 2, 2007

Related U.S. Application Data
(60) Provisional application No. 60/864,031, filed on Nov. 2, 2006.

(51) Int. Cl. G06K 9/20

(52) U.S. Cl. 382/103

(57) ABSTRACT

A system includes a tracking subsystem and a mapping subsystem. A portion of the mapping subsystem can be fixed in position relative to a portion of the tracking subsystem. The system also includes a processing subsystem in data communication with the tracking subsystem and the mapping subsystem. Other systems, methods, and articles are also described.

### CROSS-REFERENCE TO RELATED APPLICATIONS

This application claims the benefit of U.S. Provisional Pat. App. No. 60/864,031, filed on Nov. 2, 2006, the entire contents of which are incorporated by reference as part of this application.

### TECHNICAL FIELD

The disclosure relates to machine vision systems, and in particular, to systems for determining coordinates of a body.

### BACKGROUND

In many cases, it is desirable to obtain coordinates of a surface defined by an arbitrary three-dimensional body.

Known systems for obtaining coordinates of a surface defined by a three-dimensional body include marker-tracking systems, hereafter referred to as “tracking systems.” Such systems rely on probes having markers affixed thereto. In use, one touches the surface of interest using a distal tip of the probe. A pair of cameras views these markers. On the basis of the known locations of the cameras and the location of the markers as seen by each camera, such systems calculate the three-dimensional coordinates of the markers. Then, on the basis of the known relationship between the location of the marker and the location of the probe tip, the tracking system determines the coordinates of the probe's tip. With the probe's tip on the surface, those coordinates also correspond to the coordinates of the surface at that point.

A difficulty with using tracking systems in this way is that one would often like to obtain the coordinates at a great many points on the surface. This would normally require one to use the probe to contact the surface at a great many points. The procedure can thus become quite painstaking. Moreover, in some cases, the surface moves while the measurement is being made. For example, if the surface were the chest of a patient, the patient's breathing would periodically change the coordinate of each point on the moving surface. Although one can ask the patient to refrain from breathing during a measurement, there is a limit to how long a patient can comply with such a request.

Another difficulty associated with the use of tracking systems is that the nature of the surface may preclude using the probe to contact the surface. For example, the surface may be maintained at a very high temperature, in which case the probe may melt upon contacting the surface. Or, the surface may be very delicate, in which case the probe may damage, or otherwise mar the surface. Or, the surface may respond to touch in some way that disturbs the measurement. For example, if the surface were that of an infant, one might find it difficult to repeatedly probe the surface.

Additional difficulties associated with the use of tracking systems arise from inaccuracy in contacting the probe. For example, if the surface is deformable, such as skin tissue, contact with the probe may temporarily deform the surface. In some cases, the surface may be liquid. In such cases, it is difficult to accurately position the probe on the surface, particularly when surface tension of the liquid provides insufficient feedback.

An alternative method for obtaining the coordinates of many points on a surface is to use a mapping system. One type of mapping system projects a pattern, or a sequence of patterns, on the surface, obtains an image of that pattern from one or more viewpoints, and estimates the coordinates of points on the surface on the basis of the resulting images and the known locations of the viewpoints and optionally the projector. Another type of mapping system correlates image patches directly from multiple viewpoints, and combines the results thus obtained with known camera positions to generate a surface map. Such mapping systems are thus capable of obtaining many measurements at once. In addition, since no probe contacts the surface, difficulties associated with surface deformation or damage, to either the probe or the surface, evaporate.

However, mapping systems are not without their disadvantages. One such disadvantage arises from the difficulty in projecting a pattern against certain types of surfaces, such as transparent or highly reflective surfaces. Another difficulty arises from attempting to map those portions of a surface that cannot be seen from any of the available viewpoints. In addition, some mapping systems use correlation methods to match image portions seen from one viewpoint with corresponding image portions seen from another viewpoint. Such methods are occasionally prone to error.

### SUMMARY

In one aspect, a system includes: a tracking subsystem configured to obtain a first set of coordinates in a first coordinate system by tracking at least one marker; a mapping subsystem wherein a portion of the mapping subsystem is fixed in position relative to a portion of the tracking subsystem, the mapping subsystem configured to obtain a second set of coordinates in a second coordinate system characterizing a three dimensional object; and a processing subsystem in data communication with the tracking subsystem and the mapping subsystem, the processing subsystem configured to transform at least one of the first set and the second set of coordinates into a common coordinate system based at least in part on the relative positions of the fixed portions of the systems. Embodiments can include one or more of the following features.

In some embodiments, the tracking subsystem and the mapping subsystem share a camera.

In some embodiments, the tracking subsystem comprises a first camera mounted on a platform and the mapping system comprises a second camera mounted on the platform.

In some embodiments, wherein the portion of the tracking subsystem fixed in position relative to the portion of the mapping subsystem includes a first camera, and the portion of the mapping subsystem fixed in position relative to the tracking subsystem includes a second camera.

In some embodiments, the tracking subsystem provides an output relative to the common coordinate system, and the mapping subsystem provides an output relative to the common coordinate system.

In some embodiments, one of the tracking subsystem and the mapping subsystem provides an output relative to the common coordinate system, and the processor is configured to transform the output of the other of the tracking subsystem and the mapping subsystem into the common coordinate system.

In some embodiments, the processor is configured to transform the output of the tracking subsystem into the common coordinate system, and to transform the output of the mapping subsystem into the common coordinate system.

In some embodiments, the at least one marker is attached to a tool.

In some embodiments, the at least one marker is attached to a portion of the mapping subsystem.

In some embodiments, the mapping subsystem comprises a projector for projecting a pattern on the three dimensional object.

In some embodiments, the portion of the tracking subsystem fixed in position relative to the portion of the mapping subsystem includes a first reference object, and the portion of the mapping subsystem fixed in position relative to the tracking subsystem includes a second reference object. In some cases, the first reference object and the second reference object are equivalent. In some cases, the first reference object and the second reference object are discrete reference objects fixed in position relative to each other.

In one aspect, a system includes: a processing subsystem; and first and second cameras in data communication with the processing subsystem the first and second cameras being mounted in fixed spatial orientation relative to each other. The processing subsystem is configured to selectively process data provided by the first and second cameras in one of a tracking mode and a mapping mode and to provide output in a common coordinate system. Embodiments can include one or more of the following features.

In some embodiments, the first camera is mounted on a platform and the second camera is mounted on the platform.

In some embodiments, the system also includes a projector under control of the processing subsystem, wherein the processing subsystem causes the projector to project a pattern when data provided by the cameras is processed in the mapping mode.

In some embodiments, the system also includes at least one marker, wherein the processing system causes the cameras to track the marker when data provided by the cameras is processed in the tracking mode.

In one aspect, a method includes: obtaining a first set of coordinates of a three-dimensional body from mapping subsystem; obtaining a second set of coordinates from a tracking subsystem, wherein a portion of the tracking subsystem is disposed in a fixed position relative to a portion of the mapping subsystem; and transforming output of at least one of the first set and the second set of coordinates to provide a common coordinate system based on the relative positions of the fixed portions of the subsystems using a processing subsystem in data communication with the mapping subsystem and the tracking subsystem. Embodiments can include one or more of the following features.

In some embodiments, the method also includes transforming output provided by one of the mapping subsystem and the tracking subsystem in a first coordinate system to the common coordinate system. In some cases, the other of the mapping subsystem and the tracking subsystem provides output in the common coordinate system.

In some embodiments, transforming output includes comparing a position of a reference object in output from the mapping subsystem and in output from the tracking subsystem.

In one aspect, an article comprising machine-readable medium which stores executable instructions, the instructions causing a machine to: obtain a first set of coordinates characterizing a three-dimensional body from mapping subsystem; obtain a second set of the coordinates from a tracking subsystem, wherein a portion of the tracking subsystem is disposed in a fixed position relative to a portion of the mapping subsystem; and transform output of at least one of the first set and the second set of coordinates to provide a common coordinate system based on the relative positions of the fixed portions of the subsystems using a processing subsystem in data communication with the mapping subsystem and the tracking subsystem. Embodiments can include one or more of the following features.

In some embodiments, instructions cause the machine to transform output provided by one of the mapping subsystem and the tracking subsystem in a first coordinate system to the common coordinate system. In some cases, instructions cause the other of the mapping subsystem and the tracking subsystem to provide output in the common coordinate system.

In some embodiments, the instructions cause the machine to use the relative position of a reference object in output from the mapping subsystem and in output from the tracking subsystem.

In one aspect, the invention includes a machine-vision system having a tracking subsystem; a mapping subsystem; and a rigid mount for holding at least a portion of the tracking subsystem and at least a portion of the mapping subsystem in fixed spatial orientation relative to each other.

In some embodiments, the machine vision system includes a processing subsystem in data communication with both the tracking subsystem and the mapping subsystem.

Other embodiments also include those in which the tracking subsystem provides an output relative to a first coordinate system, and the mapping subsystem provides an output relative to the first coordinate system.

In yet other embodiments, the tracking subsystem and the mapping subsystem provides an output relative to a first coordinate system, and the processor is configured to transform the output of the other of the tracking subsystem and the mapping subsystem into the first coordinate system.

In some embodiments, the processor is configured to transform the output of the tracking subsystem into a first coordinate system, and to transform the output of the mapping subsystem into the first coordinate system.

In other embodiments, the tracking subsystem includes a camera and the mapping system comprises the same camera.

Additional embodiments include those in which the tracking subsystem includes a first camera and the mapping subsystem includes a second camera, and the first and second cameras share a coordinate system.

In still other embodiments, the tracking subsystem includes a camera mounted on a platform and the mapping system includes a camera mounted on the same platform.

Machine vision systems that embody the invention can also include a tool having a plurality of markers affixed thereto. These markers can be active markers, passive markers, or mix of active and passive markers. The tool can also be a probe or a surgical instrument.

In some embodiments, the mapping subsystem includes a projector for projecting a pattern on a body.

Additional embodiments of the machine vision system include those in which a portion of the tracking subsystem includes a first camera and a portion of the mapping subsystem includes a second camera.

Yet other embodiments include those in which a portion of the tracking subsystem includes a first reference object and a portion of the mapping subsystem includes a second reference object.

In another aspect, the invention includes a machine-vision system having a processing subsystem; and first and second cameras in data communication with the processing subsystem the first and second cameras being mounted in fixed spatial orientation relative to each other. The processing subsystem is configured to cause outputs of the first and second cameras to be expressed in the same coordinate system; And also to selectively process data provided by the first and second cameras in one of a tracking mode and a mapping mode.

In some embodiments, the machine vision system also includes projector under control of the processing subsystem. In such embodiments, the processing subsystem causes the projector to project a pattern when data provided by the cameras is processed in the mapping mode.

In other embodiments, the machine vision system also includes a tool having a plurality of passive markers affixed thereto; and an illumination source for illuminating the markers on the tool. The illumination source is actuated by the controller when data provided by the cameras is processed in the tracking mode.

Yet other embodiments include a tool having a plurality of active markers affixed thereto; and a power source for selectively actuating individual active markers on the tool when data provided by the cameras is processed in the tracking mode.

Additional embodiments of the machine-vision system include those that include a tool having a plurality of active markers and a plurality of passive markers affixed thereto; an illumination source for illuminating the passive markers on the tool; and a power source for selectively actuating individual active markers on the tool. In such embodiments, the illumination source and the power source are both actuated when data provided by the cameras is processed in tracking mode.

As used herein, a “body” is intended to refer to any three-dimensional object, and is not intended to be limited to the human body, whether living or dead.

Other features and advantages of the invention will be apparent from the following detailed description, from the claims, and from the accompanying figures in which:

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block-diagram of an integrated mapping system.

FIG. 2 is a diagram of a tracking subsystem.

FIG. 3 is a diagram of a mapping subsystem.

FIG. 4 is a flow chart of a tracking controller.

FIG. 5 is a flow chart of a mapping controller.

FIG. 6 is a flow chart of a data manager.

Like reference symbols in the various drawings indicate like elements.

### DETAILED DESCRIPTION

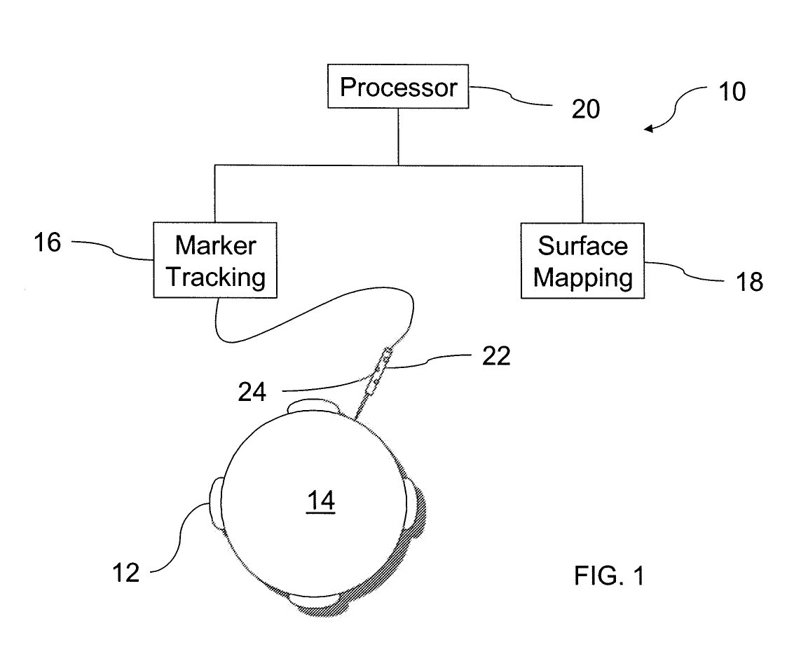

FIG. 1 shows an integrated mapping system 10 for determining coordinates of a surface 12 of a body 14. The integrated mapping system 10 includes a tracking subsystem 16 and a mapping subsystem 18. At least a portion of both the mapping subsystem 18 and the tracking subsystem 16 are rigidly mounted relative to each other. Both the mapping subsystem 18 and the tracking subsystem 16 are in communication with a common processing subsystem 20.

The processing subsystem 20 provides an output that defines a coordinate system that is common to both the tracking subsystem 16 and the mapping subsystem 18. In one embodiment, the processing subsystem 20 does so by applying a transformation to the output of one of the two subsystem 16, 18 to cause its output to be expressed in the same coordinate system as the other subsystem 18, 16. In another embodiment, the processing subsystem 20 does so by applying a transformation to the outputs of both subsystems 16, 18 to cause their respective outputs to be expressed in a common coordinate system. In another embodiment, the subsystems 16, 18 inherently share a common coordinate system. In such cases, the processing subsystem 20 need not perform a transformation on the output of either subsystem 18, 16.

The integrated mapping system 10 may operate in one of two modes: a mapping mode in which the mapping subsystem 18 is active; and a tracking mode, in which the tracking subsystem 16 is active. In some embodiments, both the mapping subsystem 18 and the tracking subsystem 16 can both be active at the same time.

The processing subsystem 20 need not be a single processor, but can also include a system in which processors and/or coprocessors cooperate with each other to carry out image processing tasks. Such processors can communicate with each other in a variety of ways, for example, across a bus, or across a network. The constituent elements of the processing subsystem 20 can be distributed among the various components of the integrated mapping system 10. For example, either the tracking subsystem 16, the mapping subsystem 18, or both might include an integrated processing element that transforms an output thereof into an appropriate coordinate system. Instructions for causing the processor(s) to carry out the image processing tasks are stored on a computer-readable medium, such as a disk or memory, accessible to the processor(s).

The tracking subsystem 16 determines the location, and possibly the orientation, of a tool 22 by tracking the location of markers 24 mounted on the tool 22. The markers 24 can be active markers, such as LEDs, or passive markers, such as retroreflectors or visible patterns, or any combination thereof. Suitable tools 22 include probes, saws, knives, and wrenches. Additional tools 22 include radiation sources, such as a laser, or an ultrasound transducer.

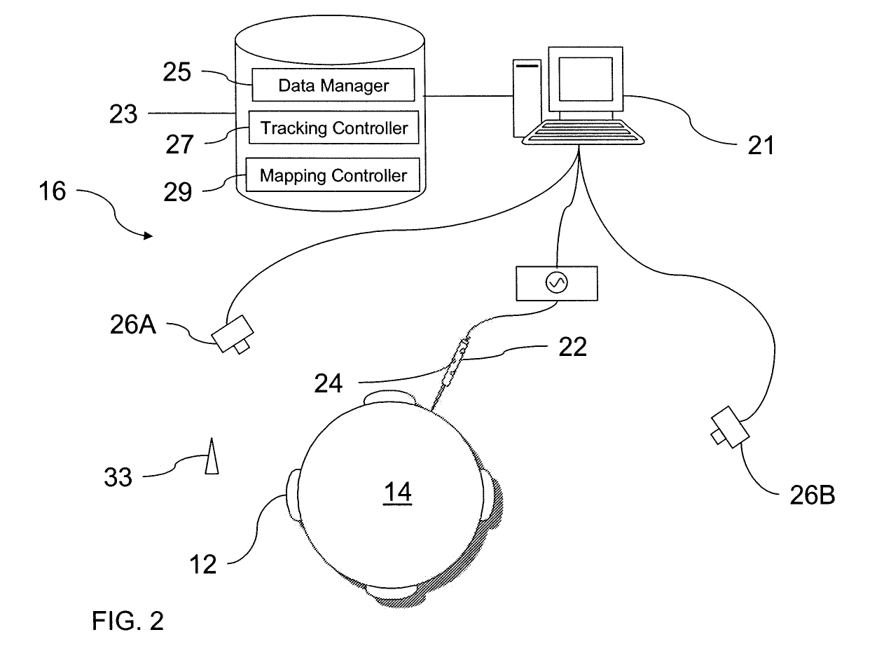

As shown in FIG. 2, a tracking subsystem 16 can include two cameras 26A, 26B in data communication with a computer system 21. In some embodiments, these two cameras 26A, 26B are rigidly mounted relative to each other. Each camera 26A, 26B independently views the markers 24 and provides, to the computer system 21, data indicative of the two-dimensional location of the markers 24 on the image. Those embodiments that use one or more active markers 24 also include a power source 28 under control of the computer system 21 for providing power to selected active markers 24 at selected times.

To operate the tracking subsystem 16, a tracking controller 27 is executed by the computer system 21. During operation of the integrated mapping system 10 in tracking mode, the tracking controller 27 uses the known locations of the two cameras 26A, 26B in a three-dimensional space, together with data provided by the cameras 26A, 26B, to triangulate the position of the tool 22 in a three-dimensional coordinate system. A set of coordinates characteristic of the body 14 being examined are calculated based on this triangulation. The tracking controller 27 outputs the set of coordinates to a data manager 25 for storage and/or further processing. In this example, the data manager 25 is also executed by computer system 21. The transfer of data from tracking controller 27 to the data manager 25 can take place on a continuous or batch basis.

In some applications, it is desirable to permit the two subsystems 16, 18 to move relative to each other. For example, the field of view of one subsystem 16, or of a camera 26A from that subsystem 16 may be momentarily obstructed, in which case that subsystem will need to be moved to maintain operation of the integrated mapping system.

To permit movement of the subsystems relative to each other, both the tracking and mapping subsystems 16, 18 can include an associated reference object. These reference objects are then mounted rigidly relative to each other. The positions of the reference objects within the fields of view of the two subsytems then provide a basis for registering the coordinate systems associated with the tracking and mapping subsystems 16, 18 into a common coordinate system.

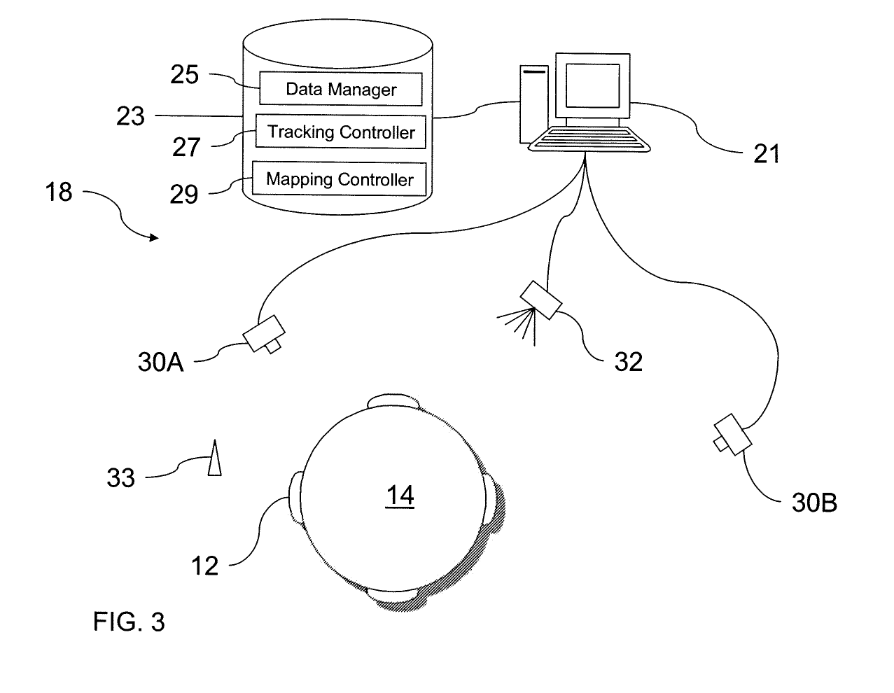

Alternatively, the subsystems 16, 18 can share the same reference object (e.g., reference object 33 as shown on FIGS. 2 and 3). The position of the reference object within the fields of view of the two cameras provides a basis for registering the coordinate systems associated with the tracking and mapping subsystems 16, 18 into a common coordinate system.

Alternatively, the reference object for one of the tracking or mapping subsystem 16 or 18 can be mounted rigidly to a portion of the other subsystem, such as the cameras 26A, 26B, 30A, 30B or projector 32.

In one embodiment, the reference object associated with the tracking subsystem 16 is a set of markers and the reference object associated with the mapping subsystem 18 is a rigid body mounted at a fixed spatial orientation relative to the set of markers. Both the rigid body and the set of markers are mounted at a stationary location relative to the body 14.

U.S. Pat. Nos. 5,923,417, 5,295,483, and 6,061,644, the contents of which are herein incorporated by reference, all disclose exemplary tracking systems, each of which can be adapted for use as a tracking subsystem 16 within the integrated mapping system 10. Additional tracking systems, each of which is adaptable for use as a tracking subsystem 16 within the integrated mapping system 10, include those sold under the trade name POLARIS by Northern Digital Inc., of Waterloo, Ontario.

In contrast to the tracking subsystem 16, the mapping subsystem 18 (sometimes referred to as a “depth mapping system”, “white light”, “structured light” or a “surface mapping system”) infers the three-dimensional coordinates of the surface 12 by illuminating the surface 12 with a pattern or by using existing patterns on the surface 12. In some embodiments, the mapping subsystem 18 includes one camera 30A and a projector 32 for projecting a pattern, such as a speckled pattern, or a sequence of patterns.

Referring to FIG. 3, in other embodiments, the mapping subsystem 18 includes two cameras 30A, 30B in data communication with the computer system 21 that together provide the computer system 21 with data representative of two independent views of the body 14. The cameras 30A, 30B can, but need not be, the same as the cameras 26A, 26B used with the tracking subsystem 16.

During operation of the integrated mapping system 10 in mapping mode, the computer system 21 executes a mapping controller 29 which receives data from each of the two cameras 30A, 30B. Using the known locations of the cameras 30A, 30B, the computer system 21 attempts to correlate regions of an image viewed by one camera 30A with corresponding regions as viewed by the other camera 30B based on the pattern on the body. Once a pair of regions is thus correlated, the computer system 21 proceeds to determine the coordinates of that portion of the body 14 that corresponds to the two image regions. This is carried out using essentially the same triangulation procedure as was used for triangulation of a marker 24. Alternately the computer system 21 receives data from the camera 30A. Using the known locations of the camera 30A and light projector 32, the computer system 21 attempts to correlate lighting elements of an image viewed by the camera 30A with the known projection pattern position from the light projector 32.

A set of coordinates characteristic of the body 14 being examined are calculated based on this triangulation and/or correlation. The mapping controller 29 outputs the set of coordinates to the data manager 25 for storage and/or further processing. The transfer of data from mapping controller 29 to the data manager 25 can take place on a continuous or batch basis.

GB 2390792 and U.S. Pat. Pub. No. 2006/0079757, filed Sep. 23, 2005, the contents of which are herein incorporated by reference, disclose exemplary mapping systems that can be adapted for use as a mapping subsystem 18 within the integrated mapping system 10. Other exemplary mapping systems that can be adapted for use as a mapping subsystem 18 within the integrated mapping system 10 include the TRICLOPS system manufactured by Point Grey Research, of Vancouver, British Columbia, and systems manufactured by Vision RT, of London, United Kingdom.

Operation of the integrated mapping system 10 in tracking mode is useful for mapping portions of the surface 12 that might otherwise be hidden, or for mapping the location of structures inside the body 14 that would not be visible to the cameras 30A, 30B. For example, one can select the tool 22 to be a probe and insert that probe deep within the body 14 until a tip of the probe contacts a structure of interest. As long as a portion of the probe having markers 24 remains visible, one can infer the coordinates of the probe's tip on the basis of the markers' coordinates and on knowledge of the probe's geometry.

Operation of the integrated mapping system 10 in tracking mode is useful for mapping surfaces that, because of their properties, would be difficult to map using the mapping subsystem 18. Such surfaces 12 include transparent surfaces, which would be difficult to see with a mapping subsystem camera 30A, 30B, or highly reflective surfaces, on which it would be difficult to see a projected pattern.

However, a tool 22, such as a probe, used while operating in tracking mode may damage or mar delicate surfaces. In addition, the probe is difficult to use accurately on soft surfaces because such surfaces deform slightly upon contact with the probe. For mapping extended surfaces, the use of a probe is tedious because one must use it to contact the surface 12 at numerous locations. In such cases, it may be desirable to switch from operating the integrated mapping system 10 in tracking mode to operating it in mapping mode.

One application of an integrated mapping system 10 is the tracking of a target relative to a body 14. For example, a surgeon may wish to track the location of a surgical instrument within a body 14. In that case, the tool 22 would be the surgical instrument, which would then have markers 24 that remain outside the body 14 so that they are visible to the cameras.

To track the target relative to the body 14, one first operates the integrated mapping system 10 in mapping mode. The mapping subsystem 18 then maps the surface 12 of the body 14. Then, one switches from mapping mode to tracking mode. This allows the tracking subsystem 16 to track the location of a suitably marked surgical instrument as it is manipulated within the body 14. Since the mapping subsystem 18 and the tracking subsystem 16 share a common platform, there is no difficulty in registration of the coordinate system used by the tracking subsystem 16 and that used by the mapping subsystem 18. In addition, since the tracking subsystem 16 and the mapping subsystem 18 share the same hardware, including the computer system 21, it is a simple matter to share data between the them.

The foregoing examples illustrate the possibility of using the integrated mapping system 10 to enable two subsystems to work in the same coordinate system. Using the integrated mapping system 10, one can use either the tracking subsystem 16 or the mapping subsystem 18 to carry out registration relative to a particular coordinate system. Having done so, the other subsystem, namely the subsystem that was not used during the initial registration, will automatically be registered with the same coordinate system.

Because its constituent subsystems share the same coordinate system, the integrated mapping system 10 requires only a single calibration step, or registration step, to calibrate, or register, two distinct subsystems. This is fundamentally different from performing two different calibration or registration procedures concurrently.

Because the constituent subsystems of the integrated mapping system 10 share the same coordinate systems, one can switch seamlessly between them. This enables one to use whichever subsystem is more convenient for registration, and to then use the other subsystem without additional registration.

Another application of the integrated mapping system 10 arises in radiotherapy, for example when one wishes to irradiate a target area. Normally, one can irradiate a target area by positioning the patient so that the target area is within a radiation source's zone of irradiation. However, if the target area is within the chest, which rises and falls with each breath, then the target area can move into and out of the zone of irradiation several times during the course of treatment. To avoid damaging adjacent tissue, it is preferable to irradiate only when the target area is actually within the zone of irradiation. To achieve this, the mapping subsystem 18 obtains a real-time map of the chest. The processing subsystem 20 then determines the appropriate time for activating the radiation source and proceeds to do so whenever the mapping subsystem 18 indicates that the chest is in the correct position. In this context, the tracking subsystem 16 could be used for registration of the radiation source and the pre-operative image sets used for tumor identification and treatment planning.

Another application of an integrated mapping system 10, which arises most often in industrial applications, is that of mapping the surface 12 of a complex part. In that case, one operates the integrated mapping system 10 in mapping mode to allow the mapping subsystem 18 to obtain the coordinates of most of the points on the part's surface 12. Then, one switches operation from the mapping mode to the tracking mode. This allows the tracking subsystem 16, in conjunction with the tool 22, to determine coordinates of the remaining points on the part. These remaining points include those that are difficult to map using the mapping subsystem 18, either because they are hidden, or because of complex geometry for which the image processing algorithms used by the mapping subsystem 18 would be prone to error. Since the mapping subsystem 18 and the tracking subsystem 16 share the same processing subsystem 20, it is a simple matter to integrate the data acquired by both systems into a single computer model of the part.

Yet another application of the integrated mapping system 10, which also arises in radiotherapy, is that of using the tracking subsystem 16 for registration of the radiation source and any pre-operative image sets that may have been used for tumor identification and treatment planning.

It is thus apparent that an integrated mapping system 10 that combines a tracking subsystem 16 and a mapping subsystem 18 on a single platform offers numerous advantages over using separate tracking and mapping systems. For example, the tracking subsystem 16 and the mapping subsystem 18 share the same processing subsystem 20. This reduces hardware requirements and enables the two subsystems 16, 18 to exchange data more easily. In addition, the integrated mapping system 10 also reduces the need to understand the transformation between coordinate frames of reference for each system.

In some embodiments, the tracking subsystem 16 and the mapping subsystem 18 also share the same cameras, further reducing hardware requirements and essentially eliminating the task of aligning coordinate systems associated with the two systems. Even in cases in which the two subsystems 16, 18 use different camera pairs, the cameras can be mounted on a common platform, or common support structure, thereby reducing the complexity associated with camera alignment. Such integrated mapping systems 10 can be pre-calibrated at the factory so that users can move them from one installation to another without the need to carry out repeated calibration and alignment.

The integrated mapping system 10 is particularly useful for mapping the surfaces of bodies that have portions out of a camera's line of sight or bodies having surfaces with a mix of hard and soft portions, bodies having surfaces with transparent or reflective portions, bodies having surfaces with a mix of delicate and rugged portions, or combinations of all the foregoing. In all of these cases, it is desirable to map some portions of the surface 12 with the mapping subsystem 16 and other portions of the surface 12 of the body 14 or the interior of the body 14 with the tracking subsystem 18. With both subsystems 16, 18 sharing a common processing subsystem 20, one can easily switch between operating the integrated mapping system 10 in tracking mode and in mapping mode as circumstances require.

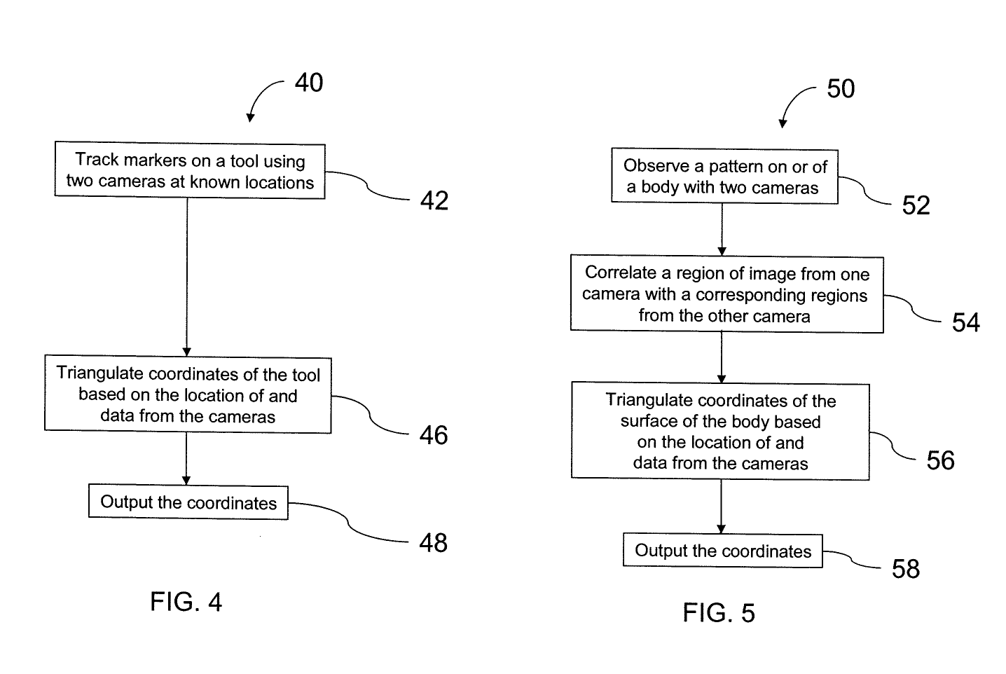

Referring to FIG. 4, a flowchart 40 represents some of the operations of the tracking controller 27 (shown in FIGS. 2 and 3). As mentioned above, the tracking controller 27 may be executed with a central system. For example, the computer system 21 or another type of computation device may execute the tracking controller 27. Furthermore, along with being executed in a single site (e.g., computer system 21 or a discrete control device associated with tracking subsystem 16), operation execution may be distributed among two or more sites. For example, some operations may be executed by a discrete control device associated with the tracking subsystem 16 and other operations may be executed with the computer system 21.

Operations of the tracking controller 27 include, in the case of active markers, activating markers on a tool before tracking 42 markers on a tool (e.g., probe 22) using cameras at two known locations. Coordinates of the tool are triangulated 46 based on the location of and data from the two cameras. The known dimensions of the tool allow a further calculation of the coordinates of a specific part or parts of the tool. For example, markers on the handle of the tool can be observed while the tip of the tool can be used to trace hard-to-observe portions of the body or object being examined. The coordinates are then output 48 by the tracking controller 27.

Referring to FIG. 5, a flowchart 50 represents some of the operations of an embodiment of the mapping controller 29 (shown in FIGS. 2 and 3). As mentioned above, the mapping controller 29 may be executed with a central system. For example, the computer system 21 or other type of computation device may execute the mapping controller 29. Furthermore, along with being executed in a single site (e.g., computer system 21 or a discrete control device associated with mapping subsystem 18), operation execution may be distributed among two or more sites. For example, some operations may be executed by a discrete control device associated with the mapping subsystem 18 and other operations may be executed with the computer system 21.

Operations of the mapping controller 29 can include projecting a pattern on the body or object of interest. One or two cameras at known locations can be used to observe 52 the body and/or the pattern on the body. In two-camera embodiments, a region of the image from one camera can be correlated 54 with a corresponding region of the image from the other camera. Optionally, this correlation can be based on the pattern on the body. Coordinates of the surface of the body are triangulated 56 based on the location of and data from a camera and a projector, from the two cameras, or from the two cameras and the projector. The coordinates are then output 58 by the mapping controller 29.

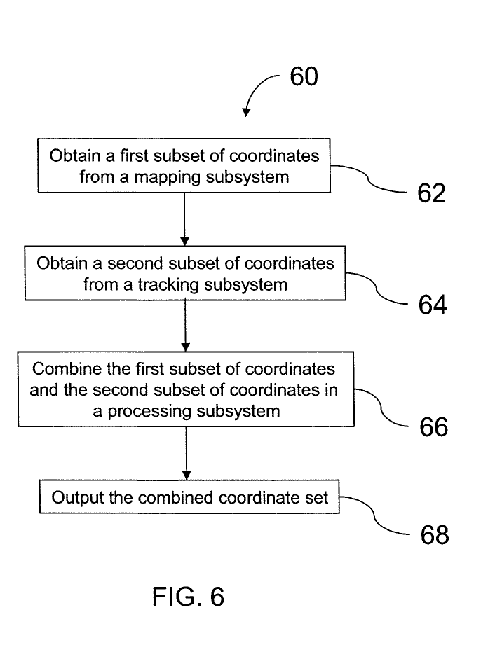

Referring to FIG. 6, a flowchart 60 represents some of the operations of the data manager 25 (shown in FIGS. 2 and 3). As mentioned above, the data manager 25 may be executed with a central system. For example, the computer system 21 or other type of computation device may execute the data manager 25. Furthermore, along with being executed in a single site (e.g., computer system 21) operation execution may be distributed among two or more sites. For example, some operations may be executed by a discrete control device associated the mapping subsystem 16, other operations may be executed by a discrete control device associated with the tracking subsystem 18, and still other operations may be executed with the computer system 21.

Operations of the data manager include obtaining 62 a first set of coordinates from a mapping subsystem and obtaining 64 a second set of the coordinates from a tracking subsystem. A portion of the tracking subsystem is disposed in a fixed position relative to a portion of the mapping subsystem. In the illustrated embodiment, obtaining the first set of coordinates 62 from the mapping subsystem occurs before the second set of coordinates is obtained from the tracking subsystem 64. However, in some embodiments, obtaining coordinates from the tracking subsystem 64 occurs simultaneously with or before obtaining coordinates from the mapping subsystem 62. The first set of the coordinates and the second set of the coordinates are then combined 66 to form a third set of coordinates. For example, a processing subsystem in data communication with the mapping subsystem and the tracking subsystem can be used to combine the first set of coordinates with the second set of coordinates. This combination can include transforming output provided by one of the mapping subsystem and the tracking subsystem in a first coordinate system to a second coordinate system with, for example, the other of the mapping subsystem and the tracking subsystem providing output in the second coordinate system. In some embodiments, transforming output includes comparing a position of a reference object in output from the mapping subsystem and/or in output from the tracking subsystem. The combined coordinates set can then be provided as output 68 by the data manager 25. Typically, data that identifies the coordinates output by the data manager 25 are stored in memory, storage device, or other type of storage unit. Data structures and files along with data storage techniques and methodologies may be implemented to store the information.

In some embodiments one or more processors may execute instructions to perform the operations of the integrated mapping system 10, e.g., respectively represented in flowcharts 40, 50, and 60. For example, one or more general processors (e.g., a microprocessor) and/or one or more specialized devices (e.g., an application specific integrated circuit (ASIC), etc.) may execute instructions. One or more of the processors may be implemented in a single integrated circuit as a monolithic structure or in a distributed structure. In some embodiments the instructions that are executed by the processors may reside in a memory (e.g., random access memory (RAM), read-only memory (ROM), static RAM (SRAM), etc.). The instructions may also be stored on one or more mass storage devices (e.g., magnetic, magneto-optical disks, or optical disks, etc.).

One or more of the operations associated with the integrated mapping system 10 may be performed by one or more programmable processors (e.g., a microprocessor, an ASIC, etc.) executing a computer program. The execution of one or more computer programs may include operating on input data (e.g., data provided from a source external to the RAM, etc.) and generating output (e.g., sending data to a destination external to the RAM, etc.). The operations may also be performed by a processor implemented as special purpose logic circuitry (e.g., an FPGA (field programmable gate array), an ASIC (application-specific integrated circuit), etc.).

Operation execution may also be executed by digital electronic circuitry, or in computer hardware, firmware, software, or in combinations of them. The operations described in flowcharts 40, 50, and 60 (along with other operations of the integrated mapping system 10) may be implemented as a computer program product, e.g., a computer program tangibly embodied in an information carrier, e.g., in a machine-readable storage device (e.g., RAM, ROM, hard-drive, CD-ROM, etc.) or in a propagated signal. The computer program product may be executed by or control the operation of, data processing apparatus, e.g., a programmable processor, a computer, or multiple computers. A computer program may be written in one or more forms of programming languages, including compiled or interpreted languages, and it can be deployed in any form, including as a stand-alone program or as a module, component, subroutine, or other unit suitable for use in a computing environment. A computer program may be deployed to be executed on one computing device (e.g., controller, computer system, etc.) or on multiple computing devices (e.g., multiple controllers) at one site or distributed across multiple sites and interconnected by a communication network.

Other embodiments are within the scope of the following claims.

What is claimed is:

1. A system comprising:
a tracking subsystem configured to obtain a first set of coordinates in a first coordinate system by tracking at least one marker;
a mapping subsystem wherein a portion of the mapping subsystem is fixed in position relative to a portion of the tracking subsystem, the mapping subsystem configured to obtain a second set of coordinates in a second coordinate system characterizing a three dimensional object; and
a processing subsystem in data communication with the tracking subsystem and the mapping subsystem, the processing subsystem configured to transform at least one of the first set and the second set of coordinates into a common coordinate system based at least in part on the relative positions of the fixed portions of the systems.

2. The system of claim 1, wherein the tracking subsystem and the mapping subsystem share a camera.

3. The system of claim 1, wherein the tracking subsystem comprises a first camera mounted on a platform and the mapping system comprises a second camera mounted on the platform.

4. The system of claim 1, wherein the portion of the tracking subsystem fixed in position relative to the portion of the mapping subsystem includes a first camera, and the portion of the mapping subsystem fixed in position relative to the tracking subsystem includes a second camera.

5. The system of claim 1, wherein
the tracking subsystem provides an output relative to the common coordinate system, and
the mapping subsystem provides an output relative to the common coordinate system.

6. The system of claim 1, wherein one of the tracking subsystem and the mapping subsystem provides an output relative to the common coordinate system, and wherein the processor is configured to transform the output of the other of the tracking subsystem and the mapping subsystem into the common coordinate system.

7. The system of claim 1, wherein the processor is configured to transform the output of the tracking subsystem into the common coordinate system, and to transform the output of the mapping subsystem into the common coordinate system.

8. The system of claim 1, wherein the at least one marker is attached to a tool.

9. The system of claim 1, wherein the at least one marker is attached to a portion of the mapping subsystem.

10. The system of claim 1, wherein the mapping subsystem comprises a projector for projecting a pattern on the three dimensional object.

11. The system of claim 1, wherein the portion of the tracking subsystem fixed in position relative to the portion of the mapping subsystem includes a first reference object, and the portion of the mapping subsystem fixed in position relative to the tracking subsystem includes a second reference object.

12. The system of claim 11, wherein the first reference object and the second reference object are equivalent.

13. The system of claim 11, wherein the first reference object and the second reference object are discrete reference objects fixed in position relative to each other.

14. A system comprising:
a processing subsystem; and
first and second cameras in data communication with the processing subsystem the first and second cameras being mounted in fixed spatial orientation relative to each other; and
wherein the processing subsystem is configured to selectively process data provided by the first and second cameras in one of a tracking mode and a mapping mode and to provide output in a common coordinate system.

15. The system of claim 14, wherein the first camera is mounted on a platform and the second camera is mounted on the platform.

16. The system of claim 14, further comprising a projector under control of the processing subsystem, wherein the processing subsystem causes the projector to project a pattern when data provided by the cameras is processed in the mapping mode.

17. The system of claim 14, further comprising: at least one marker, wherein the processing system causes the cameras to track the marker when data provided by the cameras is processed in the tracking mode.

18. A method comprising:
obtaining a first set of coordinates of a three-dimensional body from mapping subsystem;
obtaining a second set of coordinates from a tracking subsystem, wherein a portion of the tracking subsystem is disposed in a fixed position relative to a portion of the mapping subsystem; and
transforming output of at least one of the first set and the second set of coordinates to provide a common coordinate system based on the relative positions of the fixed portions of the subsystems using a processing subsystem in data communication with the mapping subsystem and the tracking subsystem.

19. The method of claim 18, comprising transforming output provided by one of the mapping subsystem and the tracking subsystem in a first coordinate system to the common coordinate system.

20. The method of claim 19, wherein the other of the mapping subsystem and the tracking subsystem provides output in the common coordinate system.

21. The method of claim 18, wherein transforming output comprises comparing a position of a reference object in output from the mapping subsystem and in output from the tracking subsystem.

22. An article comprising machine-readable medium which stores executable instructions, the instructions causing a machine to:
obtain a first set of coordinates characterizing a three-dimensional body from mapping subsystem;
obtain a second set of the coordinates from a tracking subsystem, wherein a portion of the tracking subsystem is disposed in a fixed position relative to a portion of the mapping subsystem; and
transform output of at least one of the first set and the second set of coordinates to provide a common coordinate system based on the relative positions of the fixed portions of the subsystems using a processing subsystem in data communication with the mapping subsystem and the tracking subsystem.

23. The article of claim 22, wherein instructions cause the machine to transform output provided by one of the mapping subsystem and the tracking subsystem in a first coordinate system to the common coordinate system.

24. The article of claim 23, wherein instructions cause the other of the mapping subsystem and the tracking subsystem to provide output in the common coordinate system.

25. The article of claim 22, wherein the instructions cause the machine to use the relative position of a reference object in output from the mapping subsystem and in output from the tracking subsystem.
